(19) United States
(12) Patent Application Publication
(10) Pub. No.: US 2025/0151727 A1
(43) Pub. Date: May 15, 2025

(54) (S)-ABSCISIC ACID FOR REDUCING FRUIT DROP

(71) Applicant: Valent BioSciences LLC, Libertyville, IL (US)

(72) Inventors: Ockert Petrus Jacobus Stander, Western Cape (ZA); Schalk Reynolds, Grayslake, IL (US)

(21) Appl. No.: 18/944,146

(22) Filed: Nov. 12, 2024

Related U.S. Application Data
(60) Provisional application No. 63/598,231, filed on Nov. 13, 2023.

(51) Int. Cl. A01N 37/42; A01P 21/00

(52) U.S. Cl. CPC A01N 37/42; A01P 21/00

(57) ABSTRACT

The present invention is directed to reducing fruit drop in a citrus plant comprising applying from about 0.1 to less than 150 parts per million (S)-abscisic acid, a salt thereof or a derivative thereof. The present invention is further directed to reducing fruit drop in a sweet orange tree comprising applying from about 0.1 to less than 300 parts per million (S)-abscisic acid, a salt thereof or a derivative thereof.

### FIELD OF THE INVENTION

The present invention is directed to reducing fruit drop in a citrus plant comprising applying from about 0.1 to less than 150 parts per million (S)-abscisic acid, a salt thereof or a derivative thereof. The present invention is further directed to reducing fruit drop in a sweet orange tree comprising applying from about 0.1 to less than 300 parts per million (S)-abscisic acid, or a salt thereof or a derivative thereof.

### BACKGROUND OF THE INVENTION

Citrus trees experience a natural, physiological fruit drop period that starts after 100% petal fall and lasts for approximately 64 days. When initial fruit set is high and the intensity of natural physiological fruit drop is low, thinning of fruitlets during natural, physiological fruit drop is desired to achieve the desired fruit load, fruit size and fruit quality. Thinning can be achieved by foliar application of fruit thinning agents in the form of various synthetic auxins such as dichlorprop-p, 1-naphtaleneeacetic acid and triclopyr, or the fruit can be thinned mechanically (e.g. by hand). These synthetic auxins are applied during natural, physiological fruit drop and induce ethylene synthesis which results in fruitlet thinning.

Mature fruit drop can be prevented at a later stage in the season, by foliar application of 2,4-dichlorophenoxy acetic acid shortly before harvest. However, the severity of the natural, physiological fruit drop cannot be predicted. This unpredictability is a significant commercial risk for growers and can result in significant or total yield loss, especially in certain citrus production regions and cultivars, or in certain years.

(S)-abscisic acid (“S-ABA”) is one of the 5 classical major plant hormones and is present in all terrestrial plants. The name, Abscisic acid, name resulted from the observation that S-ABA causes the abscission of cotton bolls (ref Aldicott and Davis). S-ABA also has been observed to cause fruit thinning in various crops and has been developed for this use.

Reduction of fruit drop during the natural, physiological fruit drop period by means of a foliar spray of any chemical compound is not known and this is an important unmet need for fruit tree growers.

### SUMMARY OF THE INVENTION

The present invention is directed to reducing fruit drop in a citrus plant comprising applying from about 0.1 to less than 150 parts per million (S)-abscisic acid, a salt thereof or a derivative thereof to the citrus plant.

The present invention is further directed to reducing fruit drop in a sweet orange tree comprising applying from about 0.1 to less than 300 parts per million (S)-abscisic acid, a salt thereof or a derivative thereof to the tree.

The present invention is further directed to reducing fruit drop in a lemon tree comprising applying (S)-abscisic acid, a salt thereof or a derivative thereof to the tree.

### DETAILED DESCRIPTION OF THE INVENTION

Applicant has unexpectedly discovered that application of particular concentrations of (S)-abscisic acid (“S-ABA”) results in reduced fruit drop in citrus fruits. This result is unexpected because S-ABA has previously been demonstrated to increase fruit drop abscission of other plant parts.

In one embodiment, the present invention is directed to reducing fruit drop in a citrus plant comprising applying from about 0.1 to less than 300 parts per million S-ABA, a salt thereof or a derivative thereof to the citrus plant.

In a preferred embodiment, the citrus plant is selected from the group consisting of limes, calamondin, citron, grapefruit, Japanese summer grapefruit, kumquat, lemons, mandarin, sour orange, sweet orange, pummelo, Satsuma mandarin, tachibana orange, tangelo, mandarin tangerine, tangor, trifoliate orange, uniq fruit, and cultivars, varieties and hybrids thereof. In a more preferred embodiment, the citrus plant is an orange tree or a lemon tree. In an even more preferred embodiment, the citrus plant is a sweet orange tree or a mandarin tree. In a yet even more preferred embodiment, the citrus plant is the Midknight Valencia cultivar of a sweet orange tree, an Orri cultivar of a mandarin tree or a Nadorcott cultivar of a mandarin tree. In a most preferred embodiment, the citrus plant is the Midknight Valencia cultivar of a sweet orange tree or a Nadorcott cultivar of a mandarin tree.

In another preferred embodiment, the S-ABA, a salt thereof or a derivative thereof is applied after petal fall. In a more preferred embodiment, the S-ABA, a salt thereof or a derivative thereof is applied at least 2 weeks after petal fall, more preferably at least 4 weeks after petal fall. In another more preferred embodiment, the S-ABA, a salt thereof or a derivative thereof is applied no more than 64 days after petal fall.

In a preferred embodiment, S-ABA, a salt thereof or a derivative thereof is applied to the citrus plant at a concentration from about 0.1 to less than 150 parts per million (“ppm”), more preferably from about 18.5 to less than 150 ppm, even more preferably from about 75 to less than 300 ppm, even more preferably from about 37 to about 75 ppm, even more preferably from about 75 to about 150 ppm, even more preferably from about 20 to about 80 ppm and most preferably at about 18.5, 20, 37, 40, 75, 80 or 150 ppm.

In another embodiment, the present invention is further directed to reducing fruit drop in a sweet orange tree comprising applying from about 0.1 to less than 300 ppm (S)-abscisic acid, a salt thereof or a derivative thereof, preferably from about 20 to less than 300 ppm and even more preferably from about 20 to about 150 ppm.

In another embodiment, the present invention is further directed to reducing fruit drop in a lemon tree comprising applying (S)-abscisic acid, a salt thereof or a derivative thereof, preferably from about 20 to about 80 ppm.

Cultivars, varieties and hybrids of plant parts may be from a plant which can be produced by natural hybridization, a plant which can occur as the result of a mutation, an F1 hybrid plant, or a transgenic plant (also referred to as a “genetically modified plant”).

The term “F1 hybrid plant” refers to a plant of a first filial generation which is produced by hybridizing two different varieties with each other, and is generally a plant which has a more superior trait to that of either one of parents thereof. The term “transgenic plant” refers to a plant which is produced by introducing a foreign gene from another organism such as a microorganism into a plant and which has a property that cannot be acquired easily by hybridization breeding, induction of a mutation or a naturally occurring recombination under a natural environment.

Examples of the technique for producing the above-mentioned plants include a conventional breeding technique, a transgenic technique, a genome-based breeding technique, a new breeding technique, and a genome editing technique. The conventional breeding technique is a technique for producing a plant having a desirable property by mutation or hybridization. The transgenic technique is a technique for imparting a new property to a specific organism by isolating a gene (DNA) of interest from the organism and then introducing the gene (DNA) into the genome of another target organism, and an antisense technique or an RNA interference technique which is a technique for imparting a new or improved property to a plant by silencing another gene occurring in the plant.

The genome-based breeding technique is a technique for increasing the efficiency of breeding using genomic information, and includes a DNA marker (also referred to as “genome marker” or “gene marker”) breeding technique and genomic selection. For example, the DNA marker breeding is a method in which an offspring having a desired useful trait gene is selected from many hybrid offspring using a DNA marker that is a DNA sequence capable of serving as an indicator of the position of a specific useful trait gene on a genome. The analysis of a hybrid offspring of a plant at a seedling stage thereof using the DNA marker has such a characteristic that it becomes possible to shorten the time required for breeding effectively.

The genomic selection is such a technique that a prediction equation is produced from a phenotype and genomic information both obtained in advance and then a property is predicted from the prediction equation and the genomic information without carrying out the evaluation of the phenotype. The genomic selection can contribute to the increase in efficiency of breeding. A “new breeding technique” is a collective term for a variety of breeding techniques including molecular biological techniques. Examples of the new breeding technique include techniques such as cisgenesis/intragenesis, oligonucleotide-directed mutagenesis, RNA-dependent DNA methylation, genome editing, grafting to a genetically modified rootstock or scion, reverse breeding, agroinfiltration, and seed production technology (SPT). The genome editing technique is a technique that converts genetic information in a sequence-specific manner, and enables addition, deletion and or substitution of a DNA base-pair sequence, addition, deletion and or substitution of an amino acid sequence, introduction of a foreign DNA base-pair sequence including genes and regulatory regions, and the like. Examples of the tool for the technique include zinc-finger nuclease (ZFN), TALEN, CRISPR/Cas9, CRISPER/Cpf1 and meganuclease which can cleave DNA in a sequence-specific manner, and a sequence-specific genome modification technique using CAS9 nickase, Target-AID and the like which is produced by any one of the modification of the above-mentioned tools. A skilled artisan would understand that future techniques will be developed that are capable of editing the genomic sequence, modifying transcription of a DNA sequence to an RNA sequence, modifying an RNA sequence, modifying translation of an RNA sequence to an amino acid sequence, modifying an amino acid sequence and or modifying the folding of an amino acid sequence and or agglomeration of amino acid sequences to a protein and that any or all of these techniques may be beneficial in modifying the phenotype of a plant. Plants whose phenotypes have been modified by all known and future techniques capable of modifying the phenotype of a plant are envisaged herein. Examples of the above-mentioned plant parts include parts of plants listed in genetically modified crops registration database (GM APPROVAL DATABASE) in an electronic information site in INTERNATIONAL SERVICE for the ACQUISITION of AGRI-BIOTECH APPLICATIONS, ISAAA) (http://www.isaaa.org/).

In a preferred embodiment, the S-ABA may be disposed in a composition comprising one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

The S-ABA of the present invention can be applied by any convenient means. Those skilled in the art are familiar with the modes of application including but not limited to, spraying, brushing, soaking, dipping, drenching, granule application, pressurized liquids (aerosols), vapor and fogging. Spraying includes space sprays. Space sprays include aerosols and thermal fog spray. The compositions may further be mixed with a wax and/or edible coating and applied to the plant part.

As used herein, “effective amount” refers to the amount of the S-ABA, a salt thereof or a derivative thereof that will improve cold stress tolerance, and/or plant part quality. The “effective amount” will vary depending on the S-ABA, a salt thereof or a derivative thereof concentrations, the plant species, variety, cultivar or hybrid being treated, the severity of the stress, the result desired, and the life stage of the plants, among other factors. Thus, it is not always possible to specify an exact “effective amount.” However, an appropriate “effective amount” in any individual case may be determined by one of ordinary skill in the art.

As used herein, the term “fruit drop” refers to plant parts including fruit that naturally abscise from the plant.

As used herein, the term “naturally abscise” refers to the natural detachment of a plant part including fruit via physiological means.

As used herein, “reducing” means that the number of the plant parts including fruit on one plant or the average number of plant parts including fruit per plant that naturally abscise from the plant has been reduced as compared to the number of plant parts or average plant parts per plant prior to application of S-ABA, a salt thereof or a derivative thereof or as compared to the percentage of plants parts naturally abscised from a similar plant or the average number of plant parts naturally abscised from a similar plant in a similar environment that has not received application of S-ABA, a salt thereof or a derivative thereof.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a,” “an” and “the” are intended to include the plural as well as the singular, unless the context clearly indicates otherwise.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

### EXAMPLES

### Example 1—Reduction of Fruit Drop

### Method

ProTone™ SG was applied to mature ‘Midknight Valencia’ sweet orange trees in a commercial orchard near Porterville (33°08′37.54″S, 18°59′35.90″E) in the Western Cape Province of South Africa. The experiment consisted of a completely randomized design and consisted of 10 single-tree replicates. S-ABA was applied as a foliar spray at 75, 150 and 300 parts per million (“ppm”) and compared to an untreated control (only water) at 2 liters per tree. All treatments were applied with a non-ionic wetting agent (Villa 51® having the active ingredient isotridecanol and available from Villa Crop Protection (Pty) Ltd) at a rate of 6 milliliters per 100 liters of water. Treatments were applied 28 days after 100% petal drop on 31 Oct. 2019. See Results in Table 1, below.

TABLE 1

| | | % Change in # Fruit |
|---|---|---|
| Treatment | # Fruit per Tree | per Tree |
| Untreated Control | 371 | 0 |
| S-ABA | 413 | 11% |
| 75 ppm | | |
| S-ABA | 444 | 20% |
| 150 ppm | | |
| S-ABA | 351 | −5% |
| 300 ppm | | |

### Results

As demonstrated in Table 1, the Applicant has unexpectedly found that application of S-ABA at 75 and 150 ppm reduced fruit drop in ‘Midknight Valencia’ sweet orange trees as compared to untreated control. However, application of S-ABA at 300 ppm had the expected effect of increasing fruit drop.

### Example 2—Increase in Fruit Drop

### Method

ProTone™ SG was applied to mature ‘Orri’ mandarin trees in a commercial orchard near Piketberg (33°04′46.3″S 18°50′04.7″E) in the Western Cape Province of South Africa. Two trials were conducted, one in an orchard covered with permanent shade netting, and the other in an open orchard. The experiment consisted of 5 trees per plot for each of covered and open orchard. S-ABA was applied as a foliar spray at 150 ppm and compared to an untreated control at 3.4 liters per tree for the covered orchard and 2.8 liters per tree for the open orchard. All treatments were applied with Villa 51® at a rate of 6 milliliters per 100 liters of water. Treatments were applied 28 days after 100% petal drop on 29 Nov. 2021. See Results in Table 2, below.

TABLE 2

| | | % Change in # Fruit |
|---|---|---|
| Treatment | # Fruit per Tree | per Tree |
| Untreated Control | 552 | 0 |
| (no shade) | | |
| S-ABA | 397 | −28% |
| 150 ppm | | |
| (no shade) | | |
| Untreated Control | 376 | 0 |
| (shade) | | |
| S-ABA | 82 | −78% |
| 150 ppm | | |
| (shade) | | |

### Results

As demonstrated in Table 2, the Applicant found that application of S-ABA at 150 ppm increased fruit drop in ‘Orri’ mandarin trees as compared to untreated control.

### Example 3—Reduction of Fruit Drop

### Method

ProTone™ SG or Excelero™ SL was applied to mature ‘Nadorcott’ mandarin trees in a commercial orchard near Piketberg (33°04′46.3″S 18°50′04.7″E) in the Western Cape Province of South Africa. The experiment consisted of 5 trees per plot. S-ABA in the form of ProTone™ SG was applied as a foliar spray at 18.5, 37 and 75 ppm and at 37 ppm in the form of Excelero™ SL and compared to an untreated control at 2.4 liters per tree. All treatments were applied with Villa 51® at a rate of 6 milliliters per 100 liters of water. Treatments were applied 28 days after 100% petal drop on 8 Nov. 2022. See Results in Table 3, below.

TABLE 3

| | | % Change in # Fruit |
|---|---|---|
| Treatment | # Fruit per Tree | per Tree |
| Untreated Control | 768 | 0 |
| S-ABA | 793 | 3% |
| 18.5 ppm | | |
| (ProTone ™ SG) | | |
| S-ABA | 841 | 10% |
| 37 ppm | | |
| (ProTone ™ SG) | | |
| S-ABA | 909 | 18% |
| 75 ppm | | |
| (ProTone ™ SG) | | |
| S-ABA | 1010 | 32% |
| 37 ppm | | |
| (Excelero ™ SL) | | |

### Results

As demonstrated in Table 3, the Applicant has unexpectedly found that application of S-ABA at 37 and 75 ppm reduced fruit drop in ‘Nadorcott’ mandarin trees as compared to untreated control.

### Example 4—Reduction of Fruit Drop

### Method

Excelero™ SL was applied to mature ‘Nadorcott’ mandarin trees in a commercial orchard near Piketberg (33°04′46.3″S 18°50′04.7″E) in the Western Cape Province of South Africa. The experiment consisted of 5 trees per plot. S-ABA was applied at 50 and 100 ppm in the form of Excelero™ SL and compared to an untreated control at 2.4 liters per tree. All plots received application of ProGibb® at 80% and 100% petal fall. All treatments were applied with Villa 51® at a rate of 6 milliliters per 100 liters of water. Treatments were applied 42 and 56 days after 100% petal drop (“DAP”) on 23 November and 4 Dec. 2023, respectively. See Results in Table 4, below.

TABLE 4

| | | % Change in # Fruit |
|---|---|---|
| Treatment | # Fruit per Tree | per Tree |
| Untreated Control | 306 | 0 |
| S-ABA | 412 | 35% |
| 50 ppm @ 42 DAP | | |
| (Excelero ™ SL) | | |
| S-ABA | 387 | 26% |
| 100 ppm @ 42 DAP | | |
| (Excelero ™ SL) | | |
| S-ABA | 316 | 3% |
| 50 ppm @ 56 DAP | | |
| (Excelero ™ SL) | | |
| S-ABA | 322 | 5% |
| 100 ppm @ 56 DAP | | |
| (Excelero ™ SL) | | |

### Results

As demonstrated in Table 4, the Applicant has unexpectedly found that application of S-ABA at 50 and 100 ppm at both 42 and 56 days after 100% petal drop reduced fruit drop in ‘Nadorcott’ mandarin trees as compared to untreated control.

### Example 5—Reduction of Fruit Drop

### Method

Excelero™ SL was applied to mature ‘Leanri’ mandarin trees in a commercial orchard near Ashton (33°50′57″S, 20°02′15″E) in the Western Cape Province of South Africa. The experiment consisted of 5 trees per plot. S-ABA was applied at 37 ppm in the form of ProTone™ SG and Excelero™ SL and compared to an untreated control at 2.4 liters per tree. All plots received application of Falgro® at 70% and 90% petal fall and a girdling action. All treatments were applied with Villa 51® at a rate of 6 milliliters per 100 liters of water. Treatments were applied 21 days after 100% petal drop on 8 Nov. 2023. See Results in Table 5, below.

TABLE 5

| | | % Change in # Fruit |
|---|---|---|
| Treatment | # Fruit per Tree | per Tree |
| Untreated Control | 335 | 0 |
| S-ABA | 398 | 19% |
| 37 ppm | | |
| (ProTone ™ SG) | | |
| S-ABA | 430 | 28% |
| 37 ppm | | |
| (Excelero ™ SL) | | |

### Results

As demonstrated in Table 5, the Applicant has unexpectedly found that application of S-ABA at 37 ppm at 21 days after 100% petal drop reduced fruit drop in ‘Leanri’ mandarin trees as compared to untreated control.

### Example 6—Reduction of Fruit Drop

### Method

Excelero™ SL was applied to mature ‘Orri’ mandarin trees in a commercial orchard near Mpumalanga, South Africa. The experiment consisted of a completely randomized design. S-ABA was applied at 20, 40 and 80 ppm in the form of Excelero™ SL and compared to an untreated control. All treatments were applied with Villa 51® at a rate of 6 milliliters per 100 liters of water. Treatments were applied 14, 21 and 28 days after 100% petal drop (“DAP”). See Results in Table 6, below.

TABLE 6

| | | % Change in # Fruit |
|---|---|---|
| Treatment | # Fruit per Tree | per Tree |
| Untreated Control | 189 | 0 |
| S-ABA | 222 | 17% |
| 20 ppm @ 14 DAP | | |
| (Excelero ™ SL) | | |
| S-ABA | 222 | 17% |
| 40 ppm @ 14 DAP | | |
| (Excelero ™ SL) | | |
| S-ABA | 255 | 35% |
| 80 ppm @ 14 DAP | | |
| (Excelero ™ SL) | | |
| S-ABA | 257 | 36% |
| 20 ppm @ 21 DAP | | |
| (Excelero ™ SL) | | |
| S-ABA | 234 | 24% |
| 40 ppm @ 21 DAP | | |
| (Excelero ™ SL) | | |
| S-ABA | 213 | 13% |
| 80 ppm @ 21 DAP | | |
| (Excelero ™ SL) | | |
| S-ABA | 196 | 4% |
| 20 ppm @ 28 DAP | | |
| (Excelero ™ SL) | | |
| S-ABA | 250 | 32% |
| 40 ppm @ 28 DAP | | |
| (Excelero ™ SL) | | |
| S-ABA | 207 | 10% |
| 80 ppm @ 28 DAP | | |
| (Excelero ™ SL) | | |

### Results

As demonstrated in Table 6, the Applicant has unexpectedly found that application of S-ABA at 20, 40 and 80 ppm at each of 14, 21 and 28 days after 100% petal drop reduced fruit drop in ‘Orri’ mandarin trees as compared to untreated control.

### Example 7—Reduction of Fruit Drop

### Method

Excelero™ SL was applied to mature ‘Midnight Valencia’ sweet orange trees in a commercial orchard near Mpumalanga, South Africa. The experiment consisted of a completely randomized design. S-ABA was applied at 20, 40 and 80 ppm in the form of Excelero™ SL and compared to an untreated control. All treatments were applied with Villa 51® at a rate of 6 milliliters per 100 liters of water. Treatments were applied 14, 21 and 28 days after 100% petal drop (“DAP”). See Results in Table 7, below.

TABLE 7

| | | % Change in # Fruit |
|---|---|---|
| Treatment | # Fruit per Tree | per Tree |
| Untreated Control | 201 | 0 |
| S-ABA | 239 | 19% |
| 20 ppm @ 14 DAP | | |
| (Excelero ™ SL) | | |
| S-ABA | 221 | 10% |
| 40 ppm @ 14 DAP | | |
| (Excelero ™ SL) | | |
| S-ABA | 255 | 27% |
| 80 ppm @ 14 DAP | | |
| (Excelero ™ SL) | | |
| S-ABA | 263 | 31% |
| 20 ppm @ 21 DAP | | |
| (Excelero ™ SL) | | |
| S-ABA | 246 | 22% |
| 40 ppm @ 21 DAP | | |
| (Excelero ™ SL) | | |
| S-ABA | 256 | 27% |
| 80 ppm @ 21 DAP | | |
| (Excelero ™ SL) | | |
| S-ABA | 245 | 22% |
| 20 ppm @ 28 DAP | | |
| (Excelero ™ SL) | | |
| S-ABA | 230 | 14% |
| 40 ppm @ 28 DAP | | |
| (Excelero ™ SL) | | |
| S-ABA | 285 | 42% |
| 80 ppm @ 28 DAP | | |
| (Excelero ™ SL) | | |

### Results

As demonstrated in Table 7, the Applicant has unexpectedly found that application of S-ABA at 20, 40 and 80 ppm at each of 14, 21 and 28 days after 100% petal drop reduced fruit drop in ‘Midknight Valencia’ sweet orange trees as compared to untreated control.

### Example 8—Reduction of Fruit Drop

### Method

Excelero™ SL was applied to mature ‘2PH seedless’ lemon trees in a commercial orchard near Mpumalanga, South Africa. The experiment consisted of a completely randomized design. S-ABA was applied at 20, 40 and 80 ppm in the form of Excelero™ SL and compared to an untreated control. All treatments were applied with Villa 51® at a rate of 6 milliliters per 100 liters of water. Treatments were applied 14, 21 and 28 days after 100% petal drop (“DAP”). See Results in Table 8, below.

TABLE 8

| | | % Change in # Fruit |
|---|---|---|
| Treatment | # Fruit per Tree | per Tree |
| Untreated Control | 87 | 0 |
| S-ABA | 107 | 23% |
| 20 ppm @ 14 DAP | | |
| (Excelero ™ SL) | | |
| S-ABA | 114 | 31% |
| 40 ppm @ 14 DAP | | |
| (Excelero ™ SL) | | |
| S-ABA | 109 | 25% |
| 80 ppm @ 14 DAP | | |
| (Excelero ™ SL) | | |
| S-ABA | 105 | 21% |
| 20 ppm @ 21 DAP | | |
| (Excelero ™ SL) | | |
| S-ABA | 121 | 39% |
| 40 ppm @ 21 DAP | | |
| (Excelero ™ SL) | | |
| S-ABA | 117 | 34% |
| 80 ppm @ 21 DAP | | |
| (Excelero ™ SL) | | |
| S-ABA | 112 | 29% |
| 20 ppm @ 28 DAP | | |
| (Excelero ™ SL) | | |
| S-ABA | 119 | 37% |
| 40 ppm @ 28 DAP | | |
| (Excelero ™ SL) | | |
| S-ABA | 125 | 44% |
| 80 ppm @ 28 DAP | | |
| (Excelero ™ SL) | | |

### Results

As demonstrated in Table 8, the Applicant has unexpectedly found that application of S-ABA at 20, 40 and 80 ppm at each of 14, 21 and 28 days after 100% petal drop reduced fruit drop in ‘2PH seedless’ lemon trees as compared to untreated control.

What is claimed is:

1. A method of reducing fruit drop in a citrus plant comprising applying from about 0.1 to less than 150 parts per million (S)-abscisic acid, a salt thereof or a derivative thereof to the citrus plant.

2. The method of claim 1, wherein (S)-abscisic acid, a salt thereof or a derivative thereof is applied after petal fall.

3. The method of claim 1, wherein (S)-abscisic acid, a salt thereof or a derivative thereof is applied at least 4 weeks after petal fall.

4. The method of claim 1, wherein from about 18.5 to less than 150 parts per million (S)-abscisic acid is applied.

5. The method of claim 4, wherein from about 37 to about 75 parts per million (S)-abscisic acid is applied.

6. The method of claim 1, wherein the citrus plant is an orange tree or a lemon tree.

7. The method of claim 6, wherein the orange tree is a mandarin tree or a sweet orange tree.

8. A method of reducing fruit drop in a sweet orange tree comprising applying from about 0.1 to less than 300 parts per million (S)-abscisic acid, a salt thereof or a derivative thereof to the tree.

9. The method of claim 8, wherein (S)-abscisic acid, a salt thereof or a derivative thereof is applied after petal fall.

10. The method of claim 8, wherein (S)-abscisic acid, a salt thereof or a derivative thereof is applied at least 4 weeks after petal fall.

11. The method of claim 8, wherein from about 20 to less than 300 parts per million (S)-abscisic acid, a salt thereof or a derivative thereof is applied.

12. The method of claim 8, wherein from about 20 to about 150 parts per million (S)-abscisic acid, a salt thereof or a derivative thereof is applied.

13. A method of reducing fruit drop in a lemon tree comprising applying (S)-abscisic acid, a salt thereof or a derivative thereof to the tree.

14. The method of claim 13, wherein (S)-abscisic acid, a salt thereof or a derivative thereof is applied after petal fall.

15. The method of claim 13, wherein (S)-abscisic acid, a salt thereof or a derivative thereof is applied at least 2 weeks after petal fall.

16. The method of claim 13, wherein from about 20 to about 80 parts per million (S)-abscisic acid, a salt thereof or a derivative thereof is applied.
